(19) United States
(12) Patent Application Publication
(10) Pub. No.: US 2006/0090660 A1
(43) Pub. Date: May 4, 2006

(54) Blanket for printing roll

(75) Inventor: Tae Young Oh, Seoul (KR)

Correspondence Address: MORGAN LEWIS & BOCKIUS LLP, 1111 PENNSYLVANIA AVENUE NW, WASHINGTON, DC, 20004, US

(73) Assignee: LG.Philips LCD Co.,Ltd.

(21) Appl. No.: 11/262,835

(22) Filed: Nov. 1, 2005

(30) Foreign Application Priority Data
Nov. 4, 2004 (KR) P 2004-89309

(51) Int. Cl. B41N 10/04

(52) U.S. Cl. 101/375

(57) ABSTRACT

A blanket for a printing roll is disclosed. The blanket includes a silicon-based resin layer and a fixation film on a surface of the silicon-based resin layer.

This application claims the benefit of Korean Patent Application No. P2004-89309, Nov. 4, 2004, which is hereby incorporated by reference as if fully set forth herein.

### BACKGROUND OF THE INVENTION

1. Field of the Invention

The present invention relates to a printing roll for forming a minute pattern in a liquid crystal display (LCD) device and a semiconductor device, and more particularly, to a blanket adhered to such a printing roll.

2. Discussion of the Related Art

Generally, LCD and semiconductor devices are formed with repeated steps of depositing a plurality of layers and selectively etching the deposited layers. To deposit each of the layers, a deposition process, such as the CVD (Chemical Vapor Deposition) or sputtering method, is necessary. Also, a photolithography process is typically performed to etch the deposited layer.

If the deposition and etching processes are complicated due to the formation of a number of layers in the LCD or semiconductor device, productivity is reduced. In this respect, simplified deposition and etching processes are desired for mass producing the device.

In comparison with the process of forming a desired pattern by depositing a plurality of layers with the CVD or sputtering method and patterning the deposited layers with the photolithography method, the process of forming the desired pattern by printing is simpler and requires relatively fewer steps. In the process of forming the desired pattern by printing, after a predetermined material is printed on a printing roll from a printing plate, the material printed on the printing roll is re-printed on a surface of a substrate or an underlying layer by rolling the printing roll on the substrate or underlying layer, thereby forming the desired pattern on the substrate or underlying layer. In this case, the printing method has a limited application in that the substrate comes in physical contact with the printing roll. However, the simple printing method has advantages in mass production, and the method has been developed with various modifications.

FIGS. 1A and 1B illustrate a related art printing roll and blanket. FIG. 1A shows the process for adhering the blanket to the printing roll according to the related art. FIG. 1B shows the printing roll, to which the blanket is adhered, according to the related art.

As shown in FIGS. 1A and 1B, one end of the blanket 30 is fixed to a fixing structure 20 having one end adhered to the printing roll 10. Then, while being tightened with a predetermined force, the blanket 30 is wound around and on the printing roll 10. After that, the other end of the blanket 30 is fixed to the fixing structure 20.

In the related art printing roll and blanket, the blanket 30 needs to be adhered to the printing roll 10 with a high degree of adhesion. Also, it is important that the blanket 30 can stand the straining force. Furthermore, the blanket has to have a predetermined elasticity so as to print the material layer on the substrate or underlying layer. In addition, it is important that the blanket does not become deformed during the printing process.

To satisfy these conditions for the blanket, the blanket is typically made of a silicon-based resin. The silicon-based resin has high adhesion strength for use with the printing roll. It can also be formed to apply minute patterns of layers on the substrate or underlying layer.

However, the blanket made of silicon-based resin may be deformed due to the straining force applied to it when the blanket is rolled around and adhered to the printing roll or when the printing process is performed. If the blanket on the printing roll is deformed, it becomes difficult or even impossible to print minute patterns of layers on the substrate or underlying layer.

### SUMMARY OF THE INVENTION

Accordingly, the present invention is directed to a blanket for printing roll that substantially obviate one or more problems due to limitations and disadvantages of the related art.

An object of the present invention is to provide a blanket for printing roll, which can adhere to a printing roll with a high degree of adhesion and is suitable for forming minute patterns without easily being deformed while being fixed to the printing roll or during the printing process.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a blanket for a printing roll includes a silicon-based resin layer, and a fixation film on a surface of the silicon-based resin layer.

In another aspect of the present invention, a printing apparatus for use in printing patterns of a layer in a flat panel display device or semiconductor device includes: a printing roll; and a blanket wound around and adhered to the printing roll, the blanket including a silicon-based resin layer and a fixation film on a surface of the silicon-based resin layer, wherein the fixation film adheres to the printing roll.

In yet another aspect of the present invention, a printing apparatus for use in printing patterns of a layer in a flat panel display device or semiconductor device includes: a printing roll; and a blanket wound around and adhered to the printing roll, the blanket including a silicon-based resin layer, a fixation film on a surface of the silicon-based resin layer, and an absorbing layer on a surface of the fixation film, wherein the absorbing layer adheres to the printing roll.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiments of the invention and together with the description serve to explain the principle of the invention. In the drawings:

FIG. 1A shows the process for adhering a blanket to a printing roll according to the related art;

FIG. 1B shows a printing roll, to which a blanket is adhered, according to the related art;

FIG. 2A shows a cross sectional view of a blanket according to the first exemplary embodiment of the present invention;

FIG. 2B shows a printing roll, to which a blanket of FIG. 2A is adhered, according to the first exemplary embodiment of the present invention;

FIG. 3A shows a plane view of a blanket according to the second exemplaryn embodiment of the present invention;

FIG. 3B shows a cross sectional view along I-I′ of FIG. 3A;

FIG. 3C shows a printing roll, to which a blanket of FIG. 3A and FIG. 3B is adhered, according to the second exemplary embodiment of the present invention;

FIG. 4 shows a cross sectional view of a blanket according to the third exemplary embodiment of the present invention; and

FIG. 5 shows a cross sectional view of a blanket according to the fourth exemplary embodiment of the present invention.

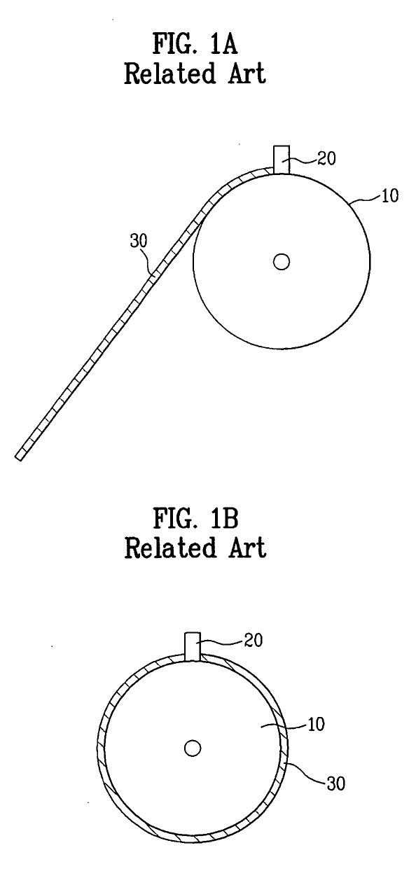

### DETAILED DESCRIPTION OF THE PREFERRED EMBODIMENTS

Reference will now be made in detail to the preferred embodiments of the present invention, examples of which are illustrated in the accompanying drawings. Wherever possible, the same reference numbers will be used throughout the drawings to refer to the same or like parts. A printing roll and a blanket according to the present invention are described below in detail with reference to the accompanying drawings.

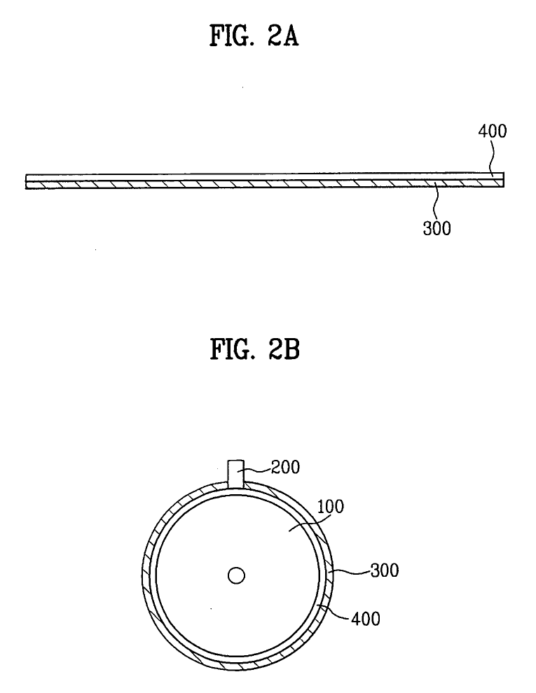

FIG. 2A shows a cross sectional view of a blanket according to the first exemplary embodiment of the present invention. FIG. 2B shows a printing roll, to which a blanket of FIG. 2A is adhered, according to the first exemplary embodiment of the present invention.

As shown in FIG. 2A, a blanket according to the first exemplary embodiment of the present invention is provided with a silicon-based resin layer 300 and a fixation film 400. The fixation film 400 is adhered to a printing roll 100. The silicon-based resin layer 300 is formed on the entire surface of the fixation film 400.

The fixation film 400 functions as a supporting film for the silicon-based resin layer 300. Also, the fixation film 400 prevents the Silicon-based resin layer 300 from being deformed while being fixed to the printing roll 100 or during the printing process. The fixation film 400 may be formed of PET-type resin.

As illustrated in FIG. 2B, the fixation film 400 comes in contact with the printing roll 100 as the fixation film 400 is wound around the printing roll 100. The fixation film 400 is fixed to the printing roll 100 by a fixing structure 200.

In the blanket according to the first exemplary embodiment of the present invention, as shown in FIG. 2A, the fixation film 400, not the silicon-based resin 300, is adhered to the printing roll 100 such that the adhesive strength between the blanket and the printing roll 100 is reduced. Accordingly, although not shown in FIG. 2B, the fixing structure 200 may require an additional fixing device. Also, if an additional fixing device is provided, an excessive force may be applied to the blanket. Thus, the elasticity of the silicon-based resin layer 300 may be reduced, thereby adversely affecting the ability to form minute patterns of layers.

To overcome these potential disadvantages of the blanket according to the first exemplary embodiment of the present invention, the blanket according to the second exemplary embodiment of the present invention is described below.

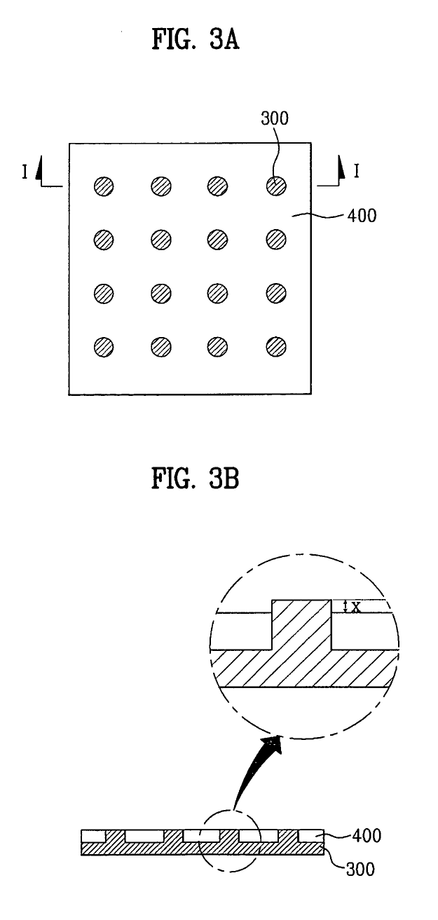

FIG. 3A shows a plane view of a blanket according to the second exemplary embodiment of the present invention. FIG. 3B shows a cross sectional view along I-I of FIG. 3A. FIG. 3C shows a printing roll, to which a blanket of FIG. 3A and FIG. 3B is adhered, according to the second exemplary embodiment of the present invention.

As shown in FIGS. 3A and 3B, a blanket according to the second embodiment of the present invention is provided with a silicon-based resin layer 300 and a fixation film 400. The fixation film 400 is formed on one surface of the silicon-based resin layer 300, which is to be adhered to a printing roll. Unlike the first exemplary embodiment of the present invention, a plurality of protrusions are formed at fixed intervals on the surface of the silicon-based resin layer 300 being adhered to the fixation film 400, as shown in FIGS. 3A and 3B. Also, as illustrated in FIGS. 3A and 3B, a plurality of holes are formed in the fixation film 400 in correspondence with the plurality of protrusions of the Silicon-based resin layer 300.

Each of the protrusions and holes may be formed in the shape of a circle, a polygon such as a tetragon or pentagon, or an ellipse. Also, the protrusions and holes may be formed in the same shape throughout, or may be formed in a combination of different shapes. The protrusions and holes may be formed in a matrix like arrangement. The size and number of the protrusions and holes may be changed based on the size of blanket.

As shown in FIG. 3B, a protrusion of the silicon-based resin layer 300 is coupled with a hole of the fixation film 400, whereby the silicon-based resin layer 300 is connected with the fixation film 400. The fixation film 400 may be made of PET-type resin.

The surfaces of the protrusions formed in the silicon-based resin layer 300 are exposed to be in contact with the printing roll. The protrusions of the silicon-based resin layer 300 may protrude from the fixation film 400 by a predetermined length (‘x’ of FIG. 3B), whereby the protrusions of the silicon-based resin layer 300 can come in contact with the printing roll.

As shown in FIG. 3C, the fixation film 400 and the protrusions of the silicon-based resin layer 300 protruding from the fixation film 400 come in contact with and adhere to the printing roll 100 as the fixation film 400 and silicon-based resin layer 300 are wound around the printing roll 100. Then, the fixation film 400 and silicon-based resin layer 300 are fixed to the printing roll 100 by a fixing structure 200.

Both the silicon-based resin layer 300 and the fixation film 400 come in contact with and adhere to the printing roll 100 such that a high degree of adhesion between the blanket and the printing roll can be attained. Thus, unlike in the first exemplary embodiment of the present invention, the fixing structure 200 may not need to include an additional fixing device. Even if an additional fixing device is provided in the fixing structure 200, excessive force is not applied to the blanket. Thus, the elasticity of the Silicon-based resin layer 300 can be maintained.

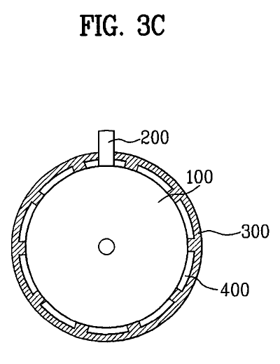

FIG. 4 shows a cross sectional view of a blanket according to the third exemplary embodiment of the present invention. As shown in FIG. 4, a blanket according to the third exemplary embodiment of the present invention is provided with a Silicon-based resin layer 300, a fixation film 400 and an absorbing layer 500. The fixation film 400 is formed on the Silicon-based resin layer 300, and the absorbing layer 500 is formed on the fixation film 400. The absorbing layer 500 is adhered to a printing roll 100 to absorb the external impact. The absorbing layer may include stylrene resin or sponge. The other features of the third exemplary embodiment are the same as the first exemplary embodiment

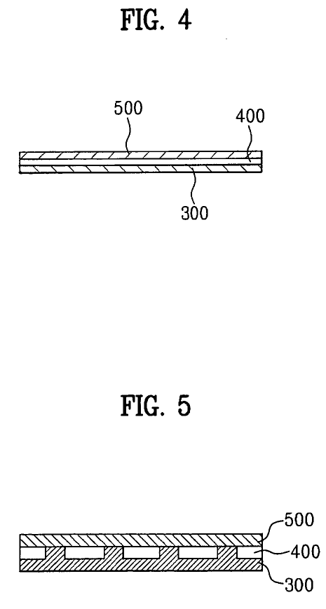

FIG. 5 shows a cross sectional view of a blanket according to the fourth exemplary embodiment of the present invention. As shown in FIG. 5, a blanket according to the fourth exemplary embodiment of the present invention is provided with a silicon-based resin layer 300, a fixation film 400 and an absorbing layer 500. The fixation film 400 is formed on the silicon-based resin layer 300, and the absorbing layer 500 is formed on the fixation film 400. The absorbing layer 500 is adhered to a printing roll 100 to absorb the external impact. The absorbing layer may include stylrene resin or sponge.

In the fourth exemplary embodiment of the present invention, a plurality of protrusions are formed at fixed intervals on the surface of the silicon-based resin layer 300 being adhered to the fixation film 400. Also, a plurality of holes are formed in the fixation film 400 in correspondence with the plurality of protrusions of the Silicon-based resin layer 300. Each of the protrusions and holes may be formed in the shape of a circle, a polygon such as a tetragon or pentagon, or an ellipse. Also, the protrusions and holes may be formed in the same shape throughout, or may be formed in a combination of different shapes. The protrusions and holes may be formed in a matrix type arrangement. The size and number of the protrusions and holes may be changed based on the size of blanket.

A protrusion of the silicon-based resin layer 300 is coupled with a hole of the fixation film 400, whereby the silicon-based resin layer 300 is connected with the fixation film 400. The fixation film 400 may be made of PET-type resin.

The surfaces of the protrusions formed in the silicon-based resin layer 300 are exposed to be in contact with the absorbing layer 500. The protrusions of the silicon-based resin layer 300 may protrude from the fixation film 400 by a predetermined length (‘x’ of FIG. 3B), whereby the protrusions of the silicon-based resin layer 300 come in contact with the absorbing layer 500.

Preferably, in the third and fourth exemplary embodiments, a thickness of the absorbing layer 500 is no less than that of the fixation film 400, and no larger than that of the Silicon-based resin layer 300. The other features of the fourth exemplary embodiment are same as the second exemplary embodiment.

As mentioned above, the blanket of the printing roll according to the present invention has the following advantages. First, the blanket is provided with the silicon-based resin layer and the fixation film, wherein the fixation film is formed in one surface of the silicon-based resin layer for adhering to the printing roll. Thus, the fixation film serves as the supporting film for the silicon-based resin layer. That is, the fixation film prevents the silicon-based resin layer from being deformed while being fixed to the printing roll or during the printing process. Also, portions of the silicon-based resin layer protrude from the fixation film and come in contact with the printing roll, resulting in a high degree of adhesion between the blanket and the printing roll.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A blanket for a printing roll, comprising:
a silicon-based resin layer; and
a fixation film on a surface of the silicon-based resin layer.

2. The blanket of claim 1, wherein the fixation film adheres to the printing roll.

3. The blanket of claim 1, wherein the silicon-based resin layer includes a plurality of protrusions, and the fixation film includes a plurality of holes in correspondence with the plurality of protrusions.

4. The blanket of claim 3, wherein each of the protrusions is coupled with a corresponding one of the holes.

5. The blanket of claim 3, wherein at least one of the protrusions of the silicon-based resin layer protrudes through the holes of the fixation film.

6. The blanket of claim 3, wherein the protrusions of the silicon-based resin layer and the fixation film adhere to the printing roll.

7. The blanket of claim 3, wherein the protrusions and holes are formed in a shape of at least one of circle, polygon and ellipse.

8. The blanket of claim 3, wherein the protrusions and holes are formed in a matrix type arrangement.

9. The blanket of claim 1, wherein the fixation film includes PET-type resin.

10. The blanket of claim 1, further comprising an absorbing layer on a surface of the fixation film.

11. The blanket of claim 10, wherein the absorbing layer adheres to the printing roll.

12. The blanket of claim 10, wherein the silicon-based resin layer includes a plurality of protrusions, and the fixation film includes a plurality of holes in correspondence with the plurality of protrusions.

13. The blanket of claim 12, wherein each of the protrusions is coupled with a corresponding one of the holes.

14. The blanket of claim 12, wherein at least one of the protrusions of the silicon-based resin layer protrudes through the corresponding hole of the fixation film to contact the absorbing layer.

15. The blanket of claim 10, wherein the absorbing layer includes stylrene resin or sponge.

16. The blanket of claim 10, wherein a thickness of the absorbing layer is no less than that of the fixation film.

17. A printing apparatus for use in printing patterns of a layer in a flat panel display device or semiconductor device, the printing apparatus comprising:
a printing roll; and
a blanket wound around and adhered to the printing roll, the blanket including a Silicon-based resin layer and a fixation film on a surface of the silicon-based resin layer, wherein the fixation film adheres to the printing roll.

18. The printing apparatus of claim 17, further comprising a fixing structure to fix the blanket to the printing roll, wherein at least one end of the blanket is tied to the fixing structure.

19. The printing apparatus of claim 17, wherein the silicon-based resin layer includes a plurality of protrusions, and the fixation film includes a plurality of holes in correspondence with the plurality of protrusions, the protrusions protruding through the holes of the fixation film to adhere to the printing roll.

20. A printing apparatus for use in printing patterns of a layer in a flat panel display device or semiconductor device, the printing apparatus comprising:
a printing roll; and
a blanket wound around and adhered to the printing roll, the blanket including a silicon-based resin layer, a fixation film on a surface of the silicon-based resin layer, and an absorbing layer on a surface of the fixation film, wherein the absorbing layer adheres to the printing roll.

21. The printing apparatus of claim 17, further comprising a fixing structure to fix the blanket to the printing roll, wherein at least one end of the blanket is tied to the fixing structure.

22. The printing apparatus of claim 17, wherein the silicon-based resin layer includes a plurality of protrusions, and the fixation film includes a plurality of holes in correspondence with the plurality of protrusions, the protrusions protruding through the holes of the fixation film to contact the absorbing layer.
